(19) United States
(12) Patent Application Publication
(10) Pub. No.: US 2007/0009047 A1
(43) Pub. Date: Jan. 11, 2007

(54) Method and apparatus for hybrid entropy encoding and decoding

(75) Inventors: Woo-sung Shim, Yongin-si (KR); Austin Lobo, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/482,811

(22) Filed: Jul. 10, 2006

(30) Foreign Application Priority Data
Jul. 8, 2005 (KR) 10-2005-0061779

(51) Int. Cl. H04N 7/12

(52) U.S. Cl. 375/240.26

(57) ABSTRACT

An apparatus and method for entropy encoding and decoding of video data. The method for entropy encoding video data includes dividing the video data into at least one partial video data portion and determining an entropy encoding mode to be used for each of the partial video data portion between at least two different entropy encoding modes and performing entropy encoding on each of the partial video data portions using the determined entropy encoding mode.

### CROSS-REFERENCE TO RELATED PATENT APPLICATION

This application claims the benefit of Korean Patent Application No. 10-2005-0061779, filed on Jul. 8, 2005, in the Korean Intellectual Property Office, the disclosure of which is incorporated herein in its entirety by reference.

### BACKGROUND OF THE INVENTION

1. Field of the Invention

Methods and apparatuses consistent with the present invention relate to video compression encoding and decoding, and more particularly, to entropy encoding and decoding of video data, in which different entropy coding methods are used for video compression.

2. Description of the Related Art

Conventionally, since computation power or memory for processing multimedia data and a transmission bandwidth are limited, complexity is limited and research aims at developing an optimal video processing technique in a specific bitrate area. However, as the development of hardware and software for processing multimedia has been accelerated and channel bandwidth for servicing multimedia has been increased and diversified, there has emerged a demand for an encoding technique having higher encoding efficiency and adaptive to various network environments. To meet the demand, the Video Coding Expert Group (VCEG) affiliated with the International Telecommunications Union-Telecommunication Standardization Sector (ITU-T) and the Moving Picture Expert Group (MPEG) of the International Organization for Standardization (ISO)/International Electrotechnical Commission (IEC) jointly have established the video encoding standard called H.264 or MPEG-4 Part 10 advanced video coding (AVC). H.264 improves encoding efficiency by 50% or more in comparison to existing standards such as the MPEG-4 Part 2 visual codec and considers error robustness and network friendliness to cope with the rapidly changing wireless environment and Internet environment.

H.264 uses context adaptive variable length coding (hereinafter, will be referred to as CAVLC) and context adaptive binary arithmetic coding (hereinafter, will be referred to as CABAC) as entropy encoding methods for compressing video data.

FIG. 1 illustrates a slice syntax according to conventional H.264.

Referring to FIG. 1, the slice syntax includes a slice header 10 and slice data 20.The slice header 10 defines a slice type and an encoded picture including slices and may include a command associated with reference picture management. The slice data 20 includes information about coded macroblocks (MB) and/or skipped (non-encoded) macroblocks (skip_run). In addition, each macroblock includes header components and coded error data.

According to H.264, in upper layers of a slice layer, syntax elements are encoded into a fixed or variable length binary code. In the slice layer or lower layers thereof, syntax elements are encoded using variable length coding (VLC) or CABAC according to an entropy encoding mode.

If entropy_coding_mode_flag is 0, residual data is encoded using CAVLC and other variable-length coded units are encoded using an Exp-Golomb code. If entropy_coding_mode_flag is 1, H.264 syntax elements are encoded and decoded using CABAC. In other words, according to the value of entropy_coding_mode_flag, the slice data 20 is encoded using one of entropy encoding methods CAVLC and CABAC.

Context modeling with respect to the other syntax elements except for the residual data, e.g., mb_type indicating, a macroblock type, coded_block_pattern indicating coded data pattern, and mb_qp_delta indicating a quantizer parameter (QP) transmitted as a delta value from a previous QP value is complicated. In other words, the other syntax elements except for the residual data occupy a smaller portion of the entire video data than the residual data, but they increase the complexity of context modeling when being encoded using CABAC. On the other hand, context modeling of the residual data is simpler than that of the other syntax elements.

However, according to conventional H.264, slice data is encoded using only one of CAVLC or CABAC and variation in the complexity of entropy encoding according to characteristics of syntax elements is not considered.

### SUMMARY OF THE INVENTION

The present invention provides an apparatus and method for entropy encoding and decoding, in which the complexity of entropy encoding for video compression is reduced and the compression rate of entropy encoding is improved.

According to one aspect of the present invention, there is provided a method for entropy encoding video data. The method includes dividing the video data into at least one partial video data portion and determining an entropy encoding mode to be used for each of the partial video data portions from between at least two different entropy encoding modes and performing entropy encoding on each of the partial video data portions using the determined entropy encoding mode.

According to another aspect of the present invention, there is provided an apparatus for entropy encoding video data. The apparatus includes a controller which divides the video data into at least one partial video data portion and determines an entropy encoding mode to be used for each of the partial video data portions from between different entropy encoding modes and an entropy encoding unit which performs entropy encoding on each of the partial video data portions according to the determined entropy encoding mode.

According to still another aspect of the present invention, there is provided a method for entropy decoding an input bitstream that is entropy encoded using at least one entropy encoding modes. The method includes dividing the input bitstream into bitstream data portions according to the entropy encoding modes and determining an entropy decoding mode for each of the bitstream data portions and performing entropy decoding on each of the bitstream data portions using the determined entropy decoding mode.

According to yet another aspect of the present invention, there is provided an apparatus for entropy decoding an input bitstream that is entropy encoded using at least one entropy encoding mode. The apparatus includes a controller which divides the input bitstream into bitstream data portions according to the entropy encoding modes and determines an entropy decoding mode for each of the bitstream data portions and an entropy decoding unit which performs entropy decoding on each of the bitstream data portions using the determined entropy decoding mode.

### BRIEF DESCRIPTION OF THE DRAWINGS

The above and other aspects of the present invention will become more apparent by describing in detail exemplary embodiments thereof with reference to the attached drawings in which:

FIG. 1 illustrates a slice syntax according to conventional H.264;

FIG. 2 is a block diagram of a video encoder using an entropy encoder according to an exemplary embodiment of the present invention;

FIG. 3 is a block diagram of an entropy encoder according to an exemplary embodiment of the present invention;

FIG. 4 illustrates data encoded by an entropy encoder according to an exemplary embodiment of the present invention;

FIG. 5 is a block diagram of a context adaptive binary arithmetic coding (CABAC) unit of FIG. 3;

FIG. 6 is a block diagram of a context adaptive variable length coding (CAVLC) unit of FIG. 3;

FIG. 7 is a flowchart illustrating an entropy encoding method according to an exemplary embodiment of the present invention;

FIG. 8 is a block diagram of a video decoder using an entropy decoder according to an exemplary embodiment of the present invention;

FIG. 9 is a block diagram of an entropy decoder according to an exemplary embodiment of the present invention;

FIG. 10 is a flowchart illustrating an entropy decoding method according to an exemplary embodiment of the present invention; and

FIG. 11 is a flowchart illustrating a method of decoding a bitstream using an entropy decoding method according to an exemplary embodiment of the present invention.

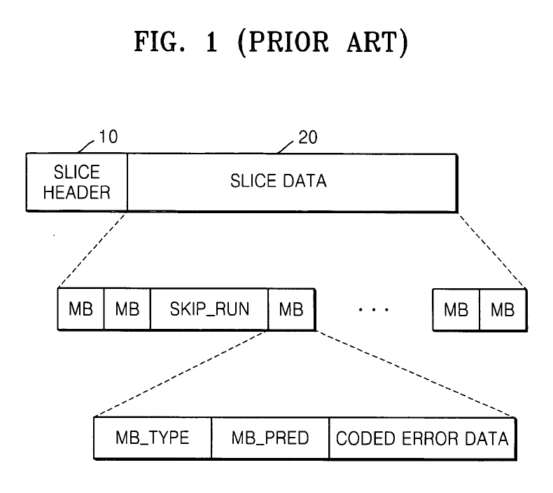

### DETAILED DESCRIPTION OF THE INVENTION

First, terms used in the following description will be defined.

CABAC: context adaptive binary arithmetic coding

CAVLC: context adaptive variable length coding

UVLC: universal variable length code. In particular, an Exp_Golumb code as a kind of UVLC is used in H.264 video codec.

I_PCM: mb_type in which sampled values without being predicted, transformed, or quantized are directly transmitted. In CABAC, when mb_type is I_PCM, all I_PCM data is read from arithmetically encoded slices and a binary arithmetic coder is restarted.

MB: macroblock

CABAC offset: term that is newly defined in the present invention. CABAC offset is a pointer indicating a slice data portion that is CABAC entropy coded from the beginning of slice data. CABAC offset is stored in a slice header.

ae(v): syntax element that is context-adaptive arithmetic entropy-coded

me(v): syntax element that is mapped Exp-Golomb-coded

se(v): syntax element that is signed integer Exp-Golomb-coded

te(v): syntax element that is truncated Exp-Golomb-coded

u(n): unsigned integer using n bits. When n is “v” on a syntax table, the number of bits changes according to other syntax elements. Parsing of u(n) is specified by the return value of a function read_bit(n) analyzed by the binary expression of an unsigned integer in which a most significant bit (MSB) is first written.

read_bit(n): function which reads n bits of a bitstream and moves a bitstream pointer by the read n bits. When n is 0, read_bit(n) returns 0 and does not move the bitstream pointer.

ue(v): syntax element that is unsigned integer Exp-Golomb-coded

f(n): a fixed pattern bit string written using n bits. Parsing of f(n) is specified by the return value of the function read_bit(n).

codIRange and codIOffset: variables indicating the range of an arithmetic coding engine and an offset state, respectively.

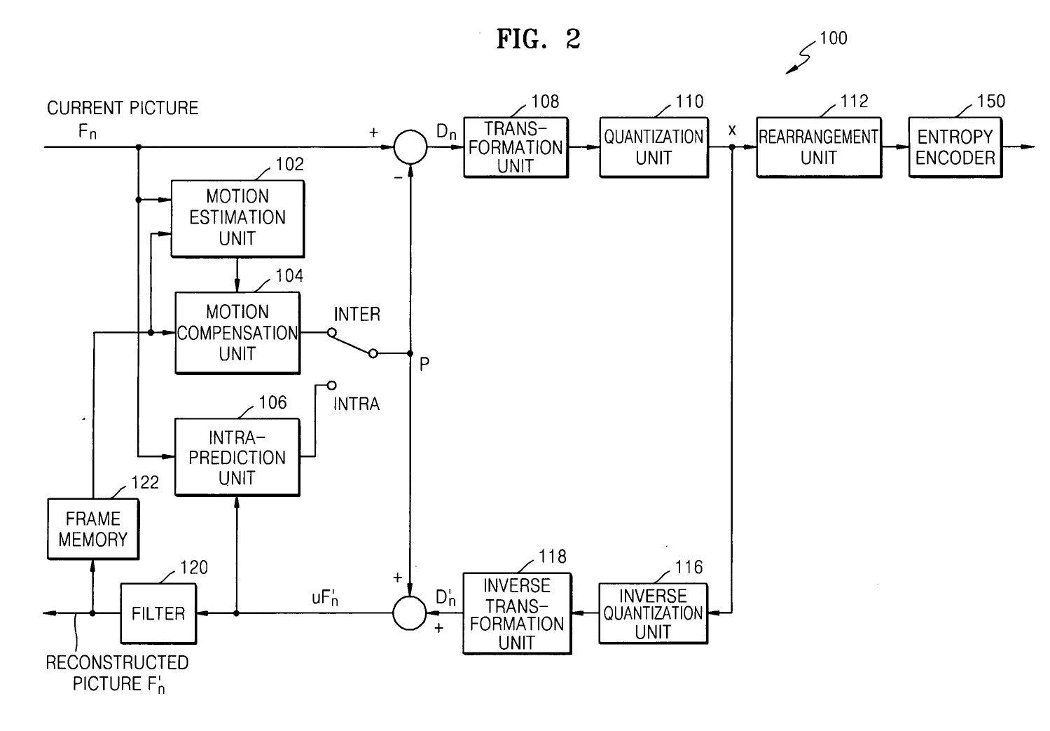

FIG. 2 is a block diagram of a video encoder using an entropy encoder according to an exemplary embodiment of the present invention.

Referring to FIG. 2, a video encoder 100 may include a motion estimation unit 102, a motion compensation unit 104, an intraprediction unit 106, a transformation unit 108, a quantization unit 110, a rearrangement unit 112, an entropy encoder 150, an inverse quantization unit 116, an inverse transformation unit 118, a filter 120, and a frame memory 122.

The motion estimation unit 102, the motion compensation unit 104, and the intraprediction unit 106 predict a current picture to be encoded using an intra mode or an inter mode, and the transformation unit 108 transforms a difference Dn between a predicted picture and the current picture into a frequency domain. The quantization unit 110 quantizes transformed data.

The entropy encoder 150 according to an exemplary embodiment of the present invention removes a statistically redundant component of video data and generates a compressed bitstream or file that can be transmitted or stored. The compressed bitstream includes a coded motion vector parameter, coded residual data, and header information. In particular, the entropy encoder 150 according to the present invention generates compressed data bitstreams corresponding to syntax elements using at least one different entropy encoding method according to the types of the syntax elements. The entropy encoder 150 according to the present invention performs entropy encoding on video data having high correlation using CABAC and on video data having low correlation using CAVLC. For example, when syntax elements according to H.264 are entropy coded, the entropy encoder 150 performs entropy encoding on all syntax elements included in residual data and a syntax element end_of slice_flag using CABAC and on the remaining syntax elements using CAVLC. This is because the residual data visually have higher correlation than other syntax elements.

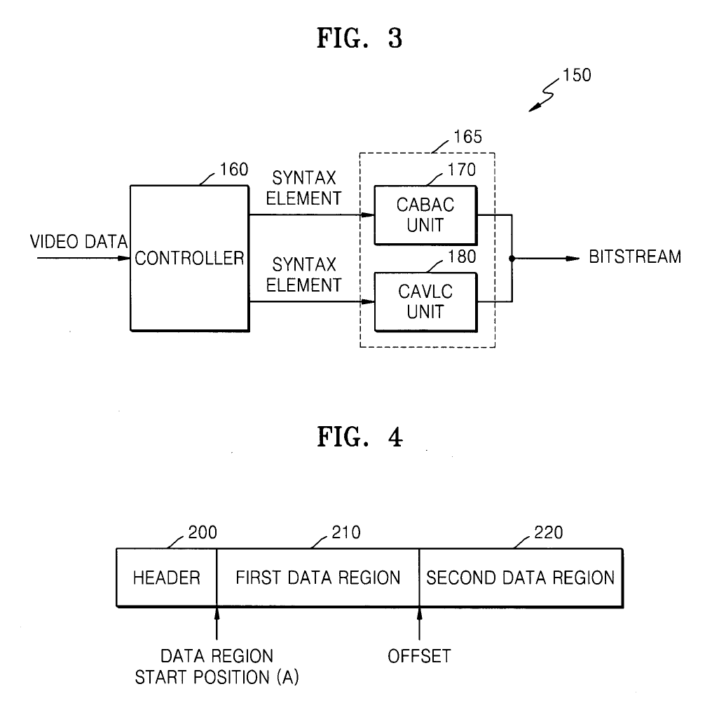

FIG. 3 is a block diagram of the entropy encoder 150 according to an exemplary embodiment of the present invention.

Referring to FIG. 3, the entropy encoder 150 according to the present invention may include a controller 160 and an entropy encoding unit 165. The entropy encoding unit 165 includes a CABAC unit 170 and a CAVLC unit 180.

The controller 160 receives video data output from a video encoder and determines which entropy encoding mode is to be used to entropy-encode the received video data according to the type of the received video data.

According to H.264, a residual block and motion estimation information are encoded by the CABAC unit 170 or the CAVLC unit 180 and output in the form of a final bitstream. Here, the residual block indicates a block having a difference between pixel values of the original block and pixel values of a reconstructed block as a pixel value. The reconstructed block is obtained by calculating a motion vector through motion estimation with respect to the original block and reconstructing the original block using the calculated motion vector.

As a result of video encoding according to H.264, after discrete cosine transformation (DCT) is performed on a residual macroblock in units of 4×4 residual blocks, the controller 160 receives DCT coefficients of the 4×4 residual blocks. The controller 160 generates a plurality of syntax elements for each of the 4×4 residual blocks, determines whether to perform CABAC or CAVLC according to the type of each of the generated syntax elements, and outputs the generated syntax elements to the CABAC unit 170 or the CAVLC unit 180.

The CABAC unit 170 performs CABAC on all syntax elements included in residual data and a syntax element end_of_slice_flag under the control of the controller 160.

The CAVLC unit 180 performs CAVLC on the remaining syntax elements except for the syntax elements included in the residual data and the syntax element end_of_slice_flag.

Syntax elements entropy-encoded by the CAVLC unit 180 are as follows.

Mb_field decoding is entropy encoded using u(1), mb_type using ue(v), transform_size_{—}8×8_flag using u(1), coded_block_pattern using me(v), mb_qp_delta using se(v), prev_intra4×4_pred_mode_flag using u(1), rem_intra4×4_pred_mode using u(3), intra_chroma_pred_mode using u(v), ref_idx_{—}10 using te(v), ref_idx_{—}11 using te(v), mvd_{—}10 using se(v), mvd_{—}11 using se(v), and sub_mb_type using ue(v). In other words, the syntax elements that are conventionally encoded using ae(v), i.e., that are context adaptive binary arithmetic encoded, are entropy encoded using CAVLC such as u(n), ue(v), me(v), and se(v). This is because the remaining syntax elements except for residual data occupies a small portion of the entire video data, but they increase the complexity of context modelling when being entropy encoded using CABAC and thus, they are entropy encoded using CAVLC having lower complexity.

In addition, mb_skip_flag is encoded using u(1) instead of ae(v). When mb_type is I_PCM, a syntax element pcm_alignment_zero_bit is entropy encoded using f(1), a syntax element pcm_sample_luma is entropy encoded using u(v), and a syntax element pcm_sample_chroma is entropy encoded using u(v).

In brief, the entropy encoder 150 according to an exemplary embodiment of the present invention performs CABAC on syntax elements associated with residual data that require simple context modelling and performs CAVLC on syntax elements that require complicated context modelling, i.e., syntax elements including additional information of the residual data, thereby improving compression efficiency while reducing complexity in encoding.

FIG. 4 illustrates data encoded by the entropy encoder 150 according to an exemplary embodiment of the present invention.

Referring to FIG. 4, data that are entropy encoded by the CABAC unit 170 and CAVLC unit 180 are stored in a first data region 210 and a second data region 220, respectively. Here, it is assumed that data that is entropy encoded by the CAVLC unit 180 is stored in the first data region 210 and data that is entropy encoded by the CABAC unit 170 is stored in the second data region 220. The controller 160 may store a difference of location between a start position A of the first data region 210 and a start position of the second data region 220 as offset information in a header 200. When entropy-encoded data is decoded according to the present invention, entropy decoding may be performed using the offset information stored in the header 200 or an entropy decoding method that is predetermined according to the type of a syntax element to be decoded.

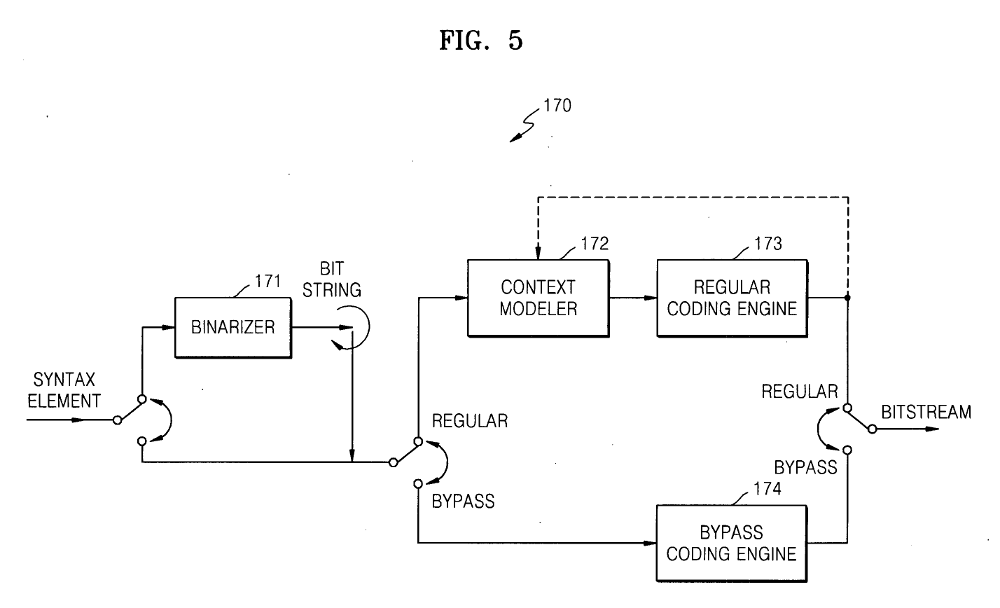

FIG. 5 is a block diagram of the CABAC unit 170 of FIG. 3.

The CABAC unit 170 according to an exemplary embodiment of the present invention may include a binarizer 171, a context modeler 172, a regular coding engine 173, and a bypass coding engine 174.

If a nonbinary valued syntax element is input, the binarizer 171 outputs a bin string by mapping the syntax element to a binary valued sequence.

Predetermined bins selected from the output bin string or binary valued syntax elements (hereinafter, the bin string or the binary valued syntax element will be referred to as a bin) do not pass through the context modeler 172, but are encoded into a bitstream by the bypass coding engine 174 to increase the processing speed of encoding. The remaining bins are input to the context modeler 172.

The context modeler 172 determines a probability model required to encode a currently input bin based on the currently input bin and a previously encoded syntax element.

The regular coding engine 173 receives the bins that are input after passing through the context modeler 172 and information about the probability model determined by the context modeler 172 and finally generates and outputs a bitstream.

The CABAC unit 170 may be used in a decoder, and in this case, a signal processing order may be inverse to the encoding process order.

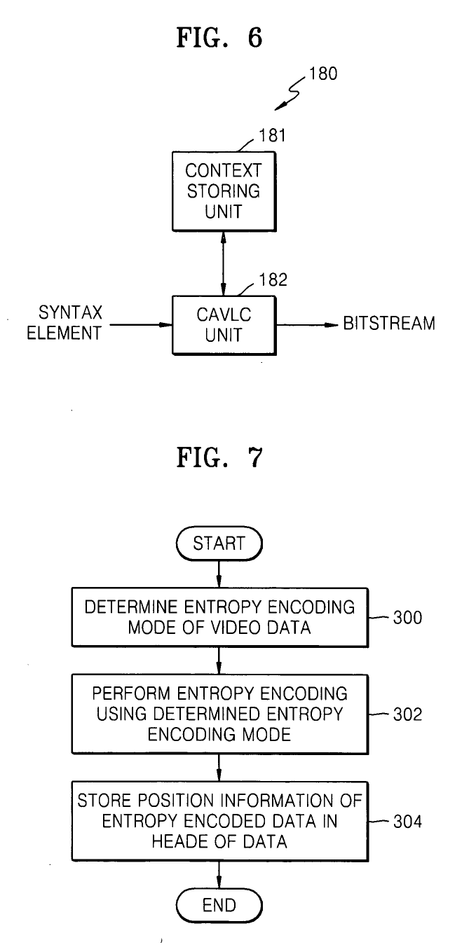

FIG. 6 is a block diagram of the CAVLC unit 180 of FIG. 3.

Motion information, prediction mode information, and transformation coefficient information included in the received syntax element are input to the CAVLC unit 182. The CAVLC unit 182 applies a variable length encoding table to the input syntax element and outputs a bitstream.

A context storing unit 181 stores information about a bitstream encoded by the CAVLC unit 182 and changes a variable length encoding table based on the information to allow entropy encoding to be adaptively performed.

The CAVLC unit 180 may be used in a decoder, and in this case, an input bitstream is processed in an order inverse to the encoding processing order.

FIG. 7 is a flowchart illustrating an entropy encoding method according to an exemplary embodiment of the present invention.

Referring to FIG. 7, it is determined which entropy encoding mode is to be used for video data in operation 300. As mentioned above, when a syntax element according to H.264 is entropy-encoded, all syntax elements included in residual data and the syntax element end_of slice_flag are entropy encoded using CABAC and the remaining syntax elements indicating information about the residual data are entropy encoded using CAVLC.

Next, entropy encoding is performed according to the determined entropy encoding mode in operation 302. To discriminate positions of data that are entropy encoded using different entropy encoding modes, difference of location between the start position of entropy encoded data using CAVLC and a start position of the entropy encoded data using CABAC can be stored in a header of the data in operation 304.

The entropy encoder according to an exemplary embodiment of the present invention is not limited to that shown in FIG. 3, but may include a plurality of different entropy encoding modules for different entropy encoding modes and perform entropy encoding using the entropy encoding methods.

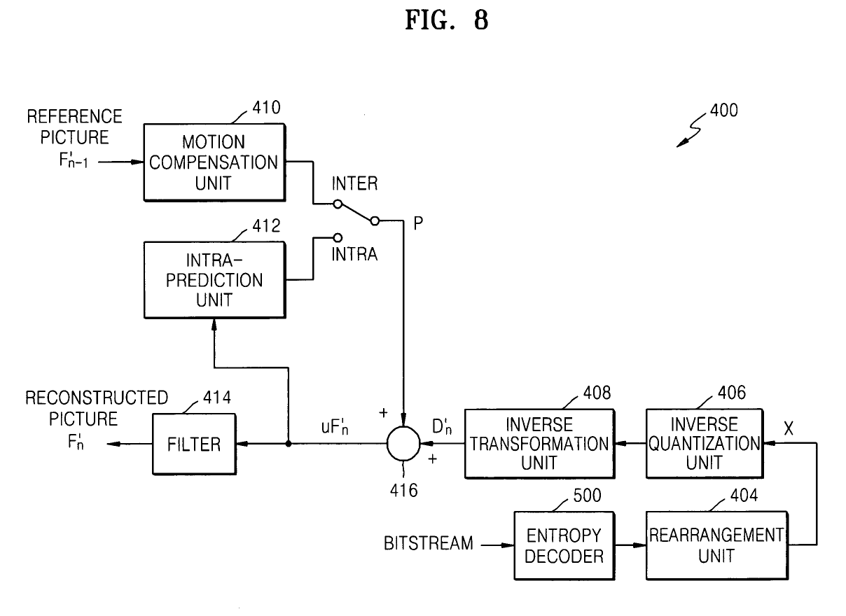

FIG. 8 is a block diagram of a video decoder using an entropy decoder according to an exemplary embodiment of the present invention.

Referring to FIG. 8, a video decoder 400 according to an exemplary embodiment of the present invention may include an entropy decoder 500, a rearrangement unit 404, an inverse quantization unit 406, an inverse transformation unit 408, a motion compensation unit 410, an intraprediction unit 412, a filter 414, and an adder 416.

The entropy decoder 500 receives and entropy-decodes a compressed bitstream to generate syntax elements and quantized coefficients X. The inverse quantization unit 406 and the inverse transformation unit 408 perform inverse quantization and inverse transformation on the decoded syntax elements and the quantized coefficients X to extract transformation encoding coefficients, motion vector information, and residual information. The motion compensation unit 410 and the intraprediction unit 412 generate a prediction block using decoded information according to an encoded picture type. The adder 416 adds an error value D′ₙ to the prediction block to generate uF′ₙ which passes through the filter 414, thereby generating a reconstructed picture F′ₙ.

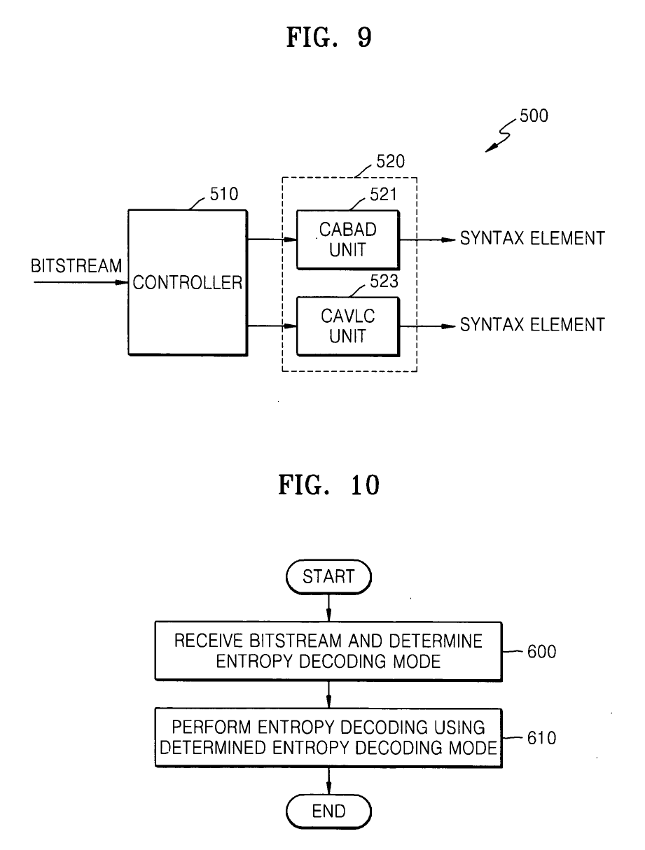

FIG. 9 is a block diagram of the entropy decoder 500 according to an exemplary embodiment of the present invention.

Referring to FIG. 9, the entropy decoder 500 may include a controller 510 and an entropy decoding unit 520. The entropy decoding unit 520 may include at least one module for performing entropy decoding according to applied entropy encoding modes. In FIG. 9, the entropy decoding unit 520 includes a context adaptive binary arithmetic decoding (hereinafter, will be referred to as CABAD) unit 521 and a context adaptive variable length decoding (hereinafter, will be referred to as CAVLD) unit 523.

The controller 510 determines which entropy decoding mode is to be used to entropy-decode current video data to be decoded. At this time, an entropy decoding mode may be predetermined according to the type of the current video data or an entropy encoding mode applied to the current video data may be determined by extracting offset information stored in a header of entropy-decoded data. The controller 510 outputs a bitstream to the entropy decoding unit 520 according to the determined entropy decoding mode. For example, a bitstream entropy encoded using CABAC is output to the CABAD unit 521 and a bitstream entropy encoded using CAVLC is output to the CAVLD unit 523.

The CABAD unit 521 and the CAVLD unit 523 perform entropy decoding on input bitstreams using corresponding entropy decoding modes and output syntax elements.

FIG. 10 is a flowchart illustrating an entropy decoding method according to an exemplary embodiment of the present invention.

Referring to FIG. 10, a bitstream is received and it is determined which entropy decoding mode is to be used to entropy decode the received bitstream in operation 600.

As described above, the entropy decoding mode can be determined by offset information stored in a header of the bitstream or the entropy decoding mode can be predetermined according to the type of a syntax element.

In operation 610, entropy decoding is performed according to the determined entropy decoding mode, thereby outputting syntax elements corresponding to the bitstream.

To decode a bitstream encoded using at least one of the entropy encoding modes, using a plurality of pointers indicating data regions encoded using different entropy encoding modes, data pointed by a pointer is read and the pointer is updated to entropy-decode data of the bitstream, which is entropy-encoded using different entropy encoding modes.

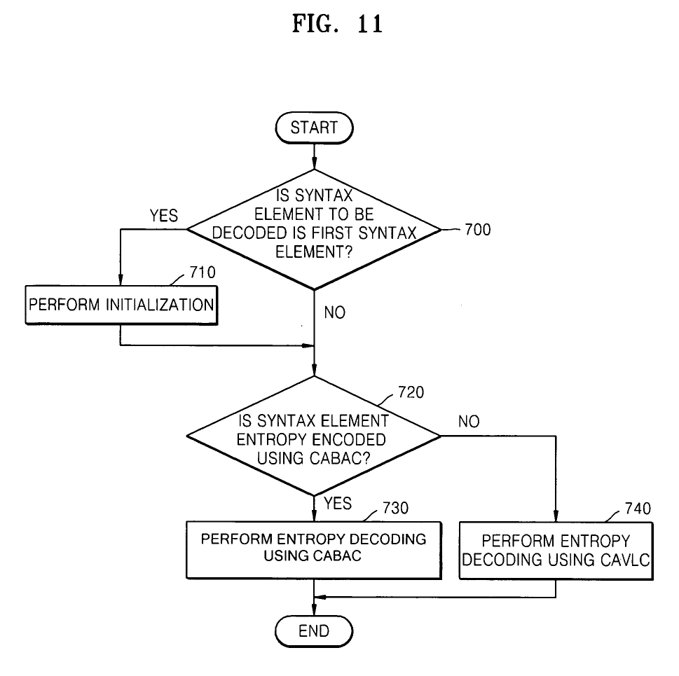

FIG. 11 is a flowchart illustrating a method of decoding a bitstream encoded using CABAC and CAVLC according to an exemplary embodiment of the present invention

Referring to FIGS. 9 and 11, the controller 510 determines whether a syntax element of an input bitstream to be decoded is the first syntax element in operation 700.

If the syntax element to be decoded is the first syntax element, initialization is performed in operation 710.

The initialization may include initialization for context parameters and initialization of an arithmetic decoding engine. The initialization for context parameters is initiated when parsing of slice data starts. Initialization of ctxidx is the same as that in decoding of conventional H.264. However, ctxidx from 0 to 84 and from 399 to 401 that are conventionally entropy encoded using CABAC are not used. This is because syntax elements indicated by ctxidx from 0 to 84 and from 399 to 401 are entropy encoded using CAVLC. Except for the syntax elements entropy encoded using CAVLC, context parameters are initialized for syntax elements indicated by ctxidx from 85 to 398 and from 402 to 459. In addition, the initialization of the arithmetic decoding engine is initiated when parsing of slice data starts and syntax elements pcm_alignment_zero_bit, pcm_sample_luma, and pcm_sample_chroma of an I_PCM-type macroblock are decoded.

The controller 510 determines which entropy encoding mode between CABAC and CAVLC is used to entropy encode a syntax element in operation 720 and performs entropy decoding using CABAD in operation 730 or entropy decoding using CAVLD in operation 740.

As described above, according to exemplary embodiments of the present invention, compression rate can be improved when compared to conventional CAVLC and complexity in computation can be reduced when compared to conventional CABAC.

By using different entropy encoding and decoding modes according to the type of video data, compression rate of the video data is improved and complexity in computation required for entropy encoding and decoding is reduced.

The present invention can also be embodied as a computer-readable code on a computer-readable recording medium. The computer-readable recording medium is any data storage device that can store data which can be thereafter read by a computer system. Examples of the computer-readable recording medium include, but are not limited to, read-only memory (ROM), random-access memory (RAM), CD-ROMs, magnetic tapes, floppy disks, optical data storage devices, and carrier waves. The computer-readable recording medium can also be distributed over network coupled computer systems so that the computer-readable code is stored and executed in a distributed fashion.

While the present invention has been particularly shown and described with reference to an exemplary embodiment thereof, it will be understood by those of ordinary skill in the art that various changes in form and details may be made therein without departing from the spirit and scope of the present invention as defined by the following claims.

What is claimed is:

1. A method for entropy encoding video data, the method comprising:
dividing the video data into partial video data portions and determining an entropy encoding mode to be used for each of the partial video data portions between at least two different entropy encoding modes; and
performing entropy encoding on each of the partial video data portions using the determined entropy encoding mode.

2. The method of claim 1, further comprising storing position information indicating positions of data entropy encoded using the different entropy encoding modes in a predetermined portion of the entropy encoded data.

3. The method of claim 2, wherein the position information is an offset indicating a difference between a start position of the entropy encoded data that are entropy encoded using one entropy encoding mode and a start point of the entropy encoded data that are entropy encoded using a different entropy encoding mode.

4. The method of claim 2, wherein the position information is stored in a header of the entropy encoded data.

5. The method of claim 1, wherein the performing of the entropy encoding on each of the partial video data portions comprises performing entropy encoding on the partial video data portions having high correlation using context adaptive binary arithmetic coding and performing entropy encoding on the partial video data portions having low correlation using context adaptive variable length coding.

6. The method of claim 1, wherein the performing of the entropy encoding on each of the partial video data portions comprises performing entropy encoding on syntax elements included in residual data and a syntax element end_of_slice_flag among syntax elements according to H.264 using context adaptive binary arithmetic coding and performing entropy encoding on the remaining syntax elements of the syntax elements according to H.264 using context adaptive variable length coding.

7. An apparatus for entropy encoding video data, the apparatus comprising:
a controller configured to divide the video data into at least one partial video data portions and determine an entropy encoding mode to be used for each of the partial video data portions between at least two different entropy encoding modes; and
an entropy encoding unit configured to perform entropy encoding on each of the partial video data portions according to the determined entropy encoding mode.

8. The apparatus of claim 7, wherein the controller stores position information indicating positions of data entropy encoded using the different entropy encoding modes in predetermined portions of the entropy encoded data.

9. The apparatus of claim 8, wherein the position information is an offset indicating a difference between a start position of the entropy encoded data that are entropy encoded using one entropy encoding mode and a start point of the entropy encoded data that are entropy encoded using another different entropy encoding mode.

10. The apparatus of claim 8, wherein the position information is stored in a header of the entropy encoded data.

11. The apparatus of claim 7, wherein the entropy encoding unit comprises:
a context adaptive binary arithmetic coding (CABAC) unit configured to perform entropy encoding on the partial video data portions having high correlation using CABAC; and
a context adaptive variable length coding (CAVLC) unit configured to perform entropy encoding on the partial video data portions having low correlation using CAVLC.

12. The apparatus of claim 7, wherein the entropy encoding unit comprises:
a context adaptive binary arithmetic coding (CABAC) unit configured to perform entropy encoding on syntax elements included in residual data and a syntax element end_of_slice_flag among syntax elements according to H.264 using CABAC; and
a context adaptive variable length coding (CAVLC) unit configured to perform entropy encoding on the remaining syntax elements of the syntax elements according to H.264 using CAVLC.

13. A method for entropy decoding an input bitstream that is entropy encoded using at least one entropy encoding mode, the method comprising:
dividing the input bitstream into bitstream data portions according to the entropy encoding modes and determining an entropy decoding mode for each of the bitstream data portions; and
performing entropy decoding on each of the bitstream data portions using the determined entropy decoding mode.

14. The method of claim 13, wherein the determining of the entropy decoding mode comprises determining an entropy decoding mode for each of the bitstream data portions divided using position information that is stored in a predetermined portion of the bitstream data portions and indicates positions of the bitstream data portions entropy encoded using different entropy encoding modes.

15. The method of claim 14, wherein the position information is an offset that is stored in a header of the bitstream data portions and indicates a difference between a start position of the entropy encoded data that are entropy encoded using one entropy encoding mode and a start point of the entropy encoded data that are entropy encoded using another different entropy encoding mode.

16. The method of claim 13, wherein the performing of the entropy decoding on each of the bitstream data portions comprises performing entropy decoding on the bitstream data portions having high correlation using context adaptive binary arithmetic decoding and performing entropy encoding on the bitstream data portions having low correlation using context adaptive variable length decoding.

17. The method of claim 13, wherein the performing of the entropy decoding on each of the bitstream data portions comprises performing entropy encoding on syntax elements included in residual data and a syntax element end_of_slice_flag among syntax elements according to H.264 using context adaptive binary arithmetic decoding and performing entropy encoding on the remaining syntax elements of the syntax elements according to H.264 using context adaptive variable length decoding.

18. An apparatus for entropy decoding an input bitstream entropy encoded using at least one entropy encoding mode, the apparatus comprising:
a controller configured to divide the input bitstream into bitstream data portions according to the entropy encoding modes and determine an entropy decoding mode for each of the bitstream data portions; and
an entropy decoding unit configured to perform entropy decoding on each of the bitstream data portions using the determined entropy decoding mode.

19. The apparatus of claim 18, wherein the controller determines an entropy decoding mode for each of the bitstream data portions divided using position information that is stored in a predetermined portion of the bitstream data portions and indicates positions of the bitstream data portions entropy encoded using different entropy encoding modes.

20. The apparatus of claim 19, wherein the position information is an offset that is stored in a header of the bitstream data portions and indicates a difference between a start position of the entropy encoded data that are entropy encoded using one entropy encoding mode and a start point of the entropy encoded data that are entropy encoded using another different entropy encoding mode.

21. The apparatus of claim 18, wherein the entropy decoding unit comprises:
a context adaptive binary arithmetic decoding (CABAD) unit configured to perform entropy encoding on the partial video data portions having high correlation using CABAD; and
a context adaptive variable length decoding (CAVLD) unit configured to perform entropy encoding on the partial video data portions having low correlation using CAVLD.

22. The apparatus of claim 18, wherein the entropy encoding unit comprises:
a context adaptive binary arithmetic decoding (CABAD) unit configured to perform entropy encoding on syntax elements included in residual data and a syntax element end_of_slice_flag among syntax elements according to H.264 using CABAD; and
a context adaptive variable length decoding (CAVLD) unit configured to perform entropy encoding on the remaining syntax elements of the syntax elements according to H.264 using CAVLD.
